(19) United States
(12) Patent Application Publication
(10) Pub. No.: US 2005/0273465 A1
(43) Pub. Date: Dec. 8, 2005

(54) Method and apparatus for community management in virtual community

(76) Inventor: Hideki Kimura, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/025,957

(22) Filed: Jan. 3, 2005

(30) Foreign Application Priority Data
Jun. 4, 2004 (JP) 2004-167005

(51) Int. Cl. G06F 7/00

(52) U.S. Cl. 707/100

(57) ABSTRACT

A method and an apparatus for community management in a virtual community are disclosed. The community management apparatus manages a management table as an electronic data containing, in correspondence with each other, the data on a community, the members of the community and the resource data providing the messages exchanged by members, and transfers the resource data from a predecessor community to a successor community. The community management apparatus receives the input of the transfer conditions. The predecessor community selected under the transfer conditions is acquired from the management table. The members corresponding to the acquired community are searched for in the management table and transferred to the successor community. The resource data corresponding to the acquired community is searched for in the management table and transferred to the successor community.

### INCORPORATION BY REFERENCE

The present application claims priority from Japanese application JP2004-167005 filed on Jun. 4, 2004, the content of which is hereby incorporated by reference into this application.

### BACKGROUND OF THE INVENTION

The present invention relates to a community transfer method, a community management apparatus and a community management program.

With the extension of the internet and the development of the communication techniques, a system has rapidly grown in which a plurality of computers exchange a predetermined message with each other through a predetermined server. In the electronic bulletin board system, for example, a contributed text (message) is disclosed to a terminal accessing the system, and the contribution of a message as a response from the terminal that has accessed the system is received. In a video conference system, on the other hand, the video information picked up by a camera is distributed to the participant terminals through a conference server.

A communication system for exchanging a message between terminals as described above is called a virtual community (hereinafter simply referred to as “the community”). The data on the messages exchanged in the virtual community are stored and supplied to the members of the community through the text data search function or the like. This technique is disclosed in JP-A-2003-30102.

### SUMMARY OF THE INVENTION

In the case where the message data stored are accessed limitlessly by the community members, it is desirable to provide a system where useful messages would not be deleted or unpleasant messages contributed, thereby making it possible maintain the order of the community. In that case, it will not be necessary to set up the right to access the stored message to permit each member to access the message data only within the scope of his/her access right.

The current practice is to create a community to achieve a predetermined object such as the software development. Therefore, it often happens that a community is created or dissolved independently, or a new community is created from an existing predetermined community with the change of the object. For example, a single community may be divided into three communities, or four communities may be integrated into a single community.

In the case where another community is created based on a predetermined community, the data on the predetermined community are desirably transferred smoothly to the new community. In the conventional community management system, however, a mechanism for efficient community transfer has not been proposed. The community manager, therefore, is required to take the trouble of manually inputting the data on the new community (such as the information on the setting of the access right).

In view of this, the primary object of the invention is to solve the above-mentioned problem and secure smooth community transfer.

In order to solve the problem, according to the present invention, there is provided a community transfer method in which a community management apparatus for managing a management table containing the electronic data, in correspondence with each other, on a community, members of the community and the resource data including the messages exchanged by the members, transfers the community data from a predecessor community to a successor community, comprising the steps of:
the community management apparatus receiving an input of transfer conditions, acquiring a predecessor community selected under the transfer conditions from the management table, searching the management table for members corresponding to the acquired community and transferring the members to the successor community, and searching the management table for the resource data corresponding to the acquired community and transferring the resource data to the successor community. Other means are described in the embodiments below.

This invention has the feature in that the data on a selected predecessor community are transferred to a successor community. As a result, the user can smoothly succeed to a community simply by selecting a predecessor community.

### BRIEF DESCRIPTION OF THE DRAWINGS

FIG. 1A is a diagram for explaining the community transfer process based on a single community according to an embodiment of the invention.

FIG. 1B is a diagram for explaining the community transfer process based on a single community according to an embodiment of the invention.

FIG. 2A is a diagram for explaining the community transfer process based on a plurality of communities according to an embodiment of the invention.

FIG. 2B is a diagram for explaining the community transfer process based on a plurality of communities according to an embodiment of the invention.

FIG. 3 is a diagram showing a configuration of a community management apparatus according to an embodiment of the invention.

FIG. 4 is a diagram showing a configuration of a community management unit and a member management unit of the community management apparatus according to an embodiment of the invention.

FIG. 5 is a diagram showing a configuration of a resource management unit of the community management apparatus and a role correspondence table according to an embodiment of the invention.

FIG. 6 is a diagram showing a screen of a transfer condition input unit by way of which the community management apparatus causes the user to input the transfer conditions according to an embodiment of the invention.

FIG. 7 is a flowchart of the community transfer process executed by the community management apparatus according to an embodiment of the invention.

FIG. 8 is a flowchart of the member transfer process executed by the community management apparatus according to an embodiment of the invention.

FIG. 9A is a diagram for explaining the role priority order according to an embodiment of the invention.

FIG. 9B is a diagram for explaining the role priority order according to an embodiment of the invention.

### DETAILED DESCRIPTION OF THE INVENTION

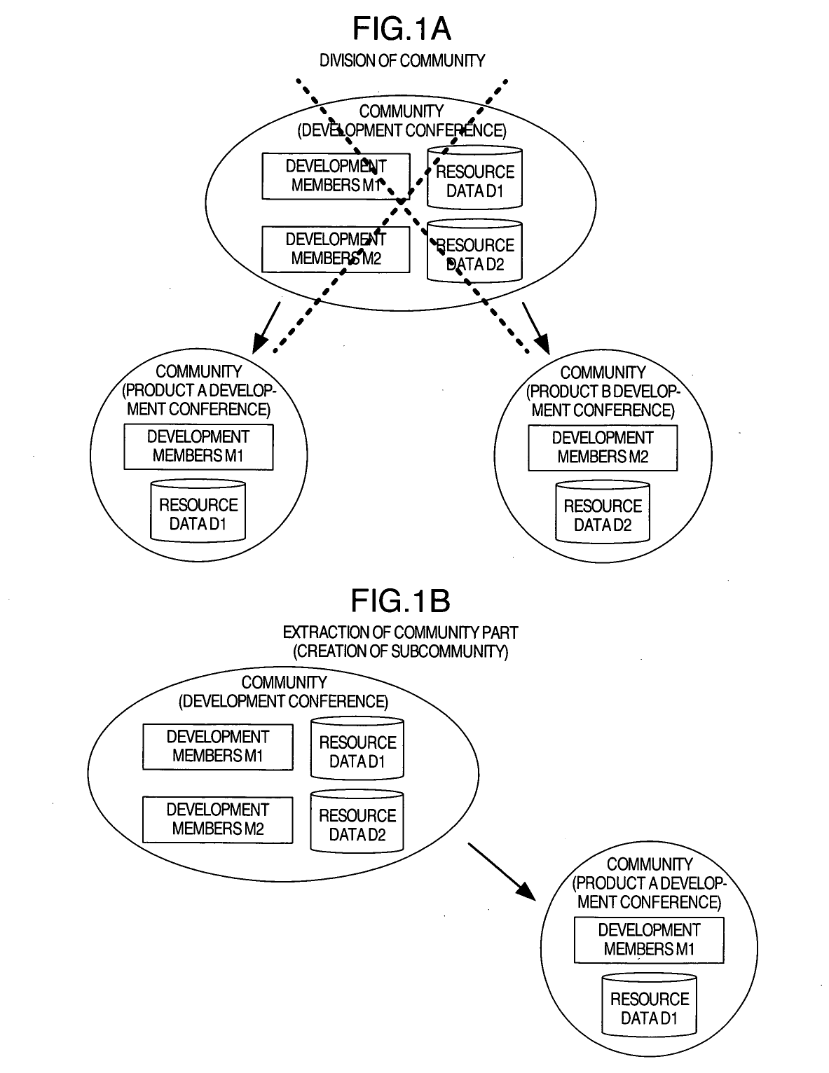

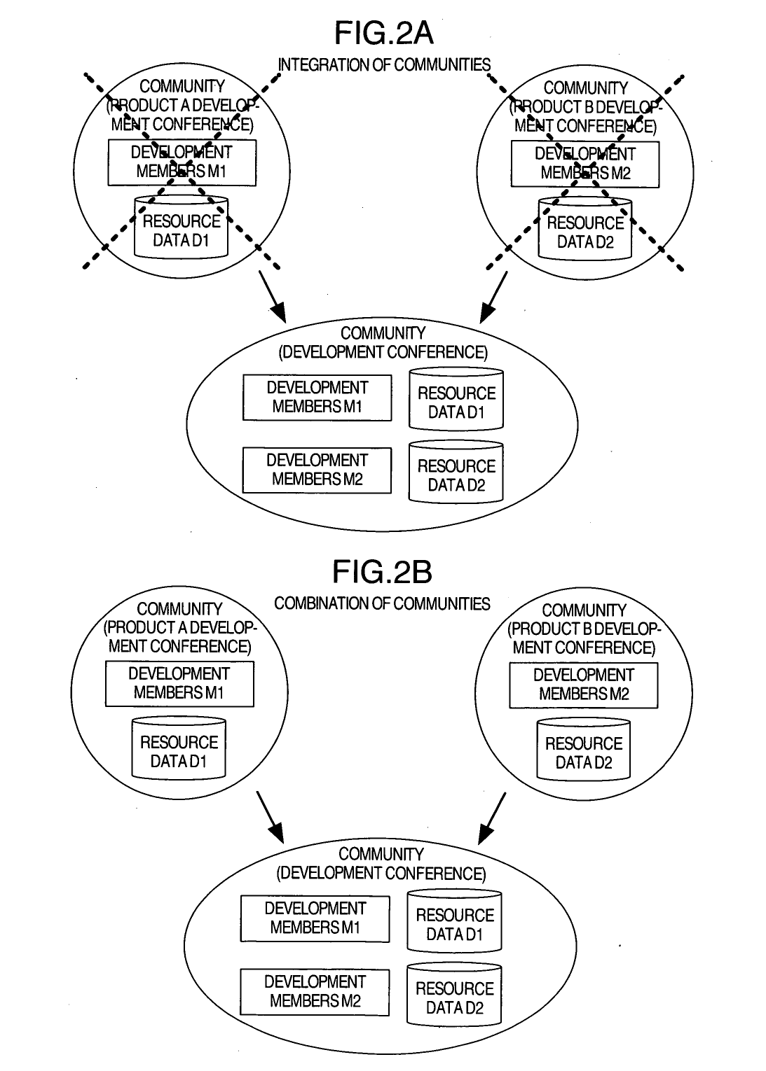

A community management apparatus according to an embodiment of the invention is explained in detail below with reference to the drawings. The concept of the community transfer according to this embodiment is explained with reference to FIGS. 1A, 1B, 2A and 2B.

A community is a place where the members of the community exchange messages with each other. Means used for exchanging a message include such services (applications) as an electronic conference room based on WWW (World Wide Web), file sharing and a video conference system. Specifically, the message handled in the community according to this embodiment is not limited to a specific form (e.g. text), but various forms including the dynamic image and the voice are usable. The messages exchanged by the members in the services described above are accumulated as resource data of the community. The members can exchange additional messages by accessing the messages in store (citing the text data, for example).

Next, according to this embodiment, the right to access each resource data is set for each member of the community in accordance with the experience and the reliability of the particular member. Each member is permitted to exchange and access a message within the scope of the access right assigned to him/her. This is by reason of the fact that if a member low in reliability is permitted to access each resource data unconditionally, a useful message would be deleted or an unpleasant message would be contributed and the order of the community would become difficult to maintain.

Further, according to this embodiment, a community is “transferred” from an predecessor community to a successor community, so that communities are developed in succession from a predetermined one to another one. The community transfer is classified into the transfer from a single predecessor community (FIGS. 1A, 1B) and the transfer from a plurality of predecessor communities (FIGS. 2A, 2B).

FIGS. 1A and 1B are diagrams for explaining the community transfer process based on a single community. Each circle indicates a community, and arrows between the circles indicate the community transfer relation (the forward end of each arrow indicates a successor community). FIG. 1A shows a community division process and FIG. 1B a community part extraction process (subcommunity creation process). The difference between FIG. 1A and FIG. 1B is whether the predecessor community is deleted (FIG. 1A) or not deleted (FIG. 1B) after community transfer. The predecessor community (development conference) is marked by a dashed X in FIG. 1A.

FIG. 2 is a diagram for explaining the community transfer process based on a plurality of communities. FIG. 2A shows a community integration process, and FIG. 2B a community combination process. The difference between FIG. 2A and FIG. 2B lies in whether predecessor communities are deleted (FIG. 2A) or not deleted (FIG. 2B) after community transfer. In FIG. 2A, the predecessor communities (the product A development conference and the product B development conference) are marked by a dashed X indicating the deletion.

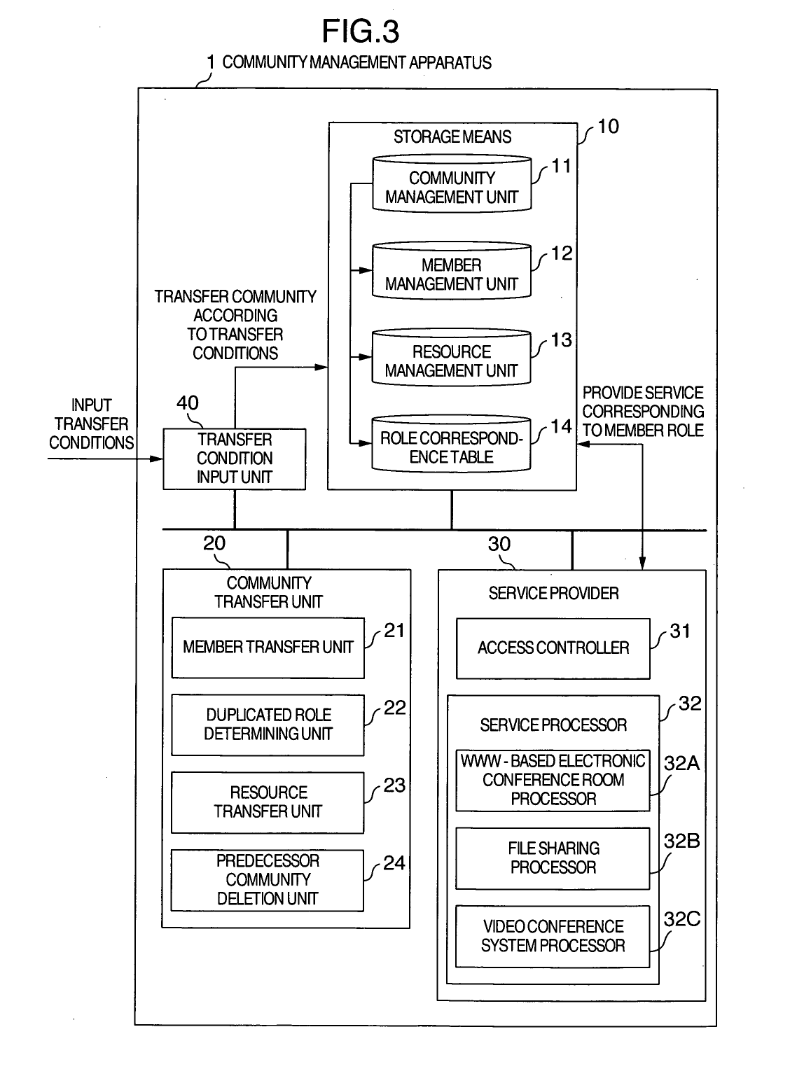

Next, the configuration of the community management apparatus according to this embodiment is explained with reference to FIGS. 3 to 6.

FIG. 3 is a diagram showing a configuration of the community management apparatus. The community management apparatus 1 has the function of managing the data on the communities and transferring the communities efficiently. For this purpose, the community management apparatus 1 comprises a storage means 10 for storing the data, a community transfer unit 20 for creating a successor community from a predecessor community, a service provider 30 for providing the community services, and a transfer condition input unit 40 for receiving the input of the conditions for creating a successor community.

The community management apparatus 1 is configured as a computer including at least a memory providing a storage area used for the arithmetic operation and an operation processor for executing the arithmetic operation. The storage means 10 is configured of the memory, while the community transfer unit 20, the service provider 30 and the transfer condition input unit 40 are configured as a program executed by the operation processor (CPU: central processing unit).

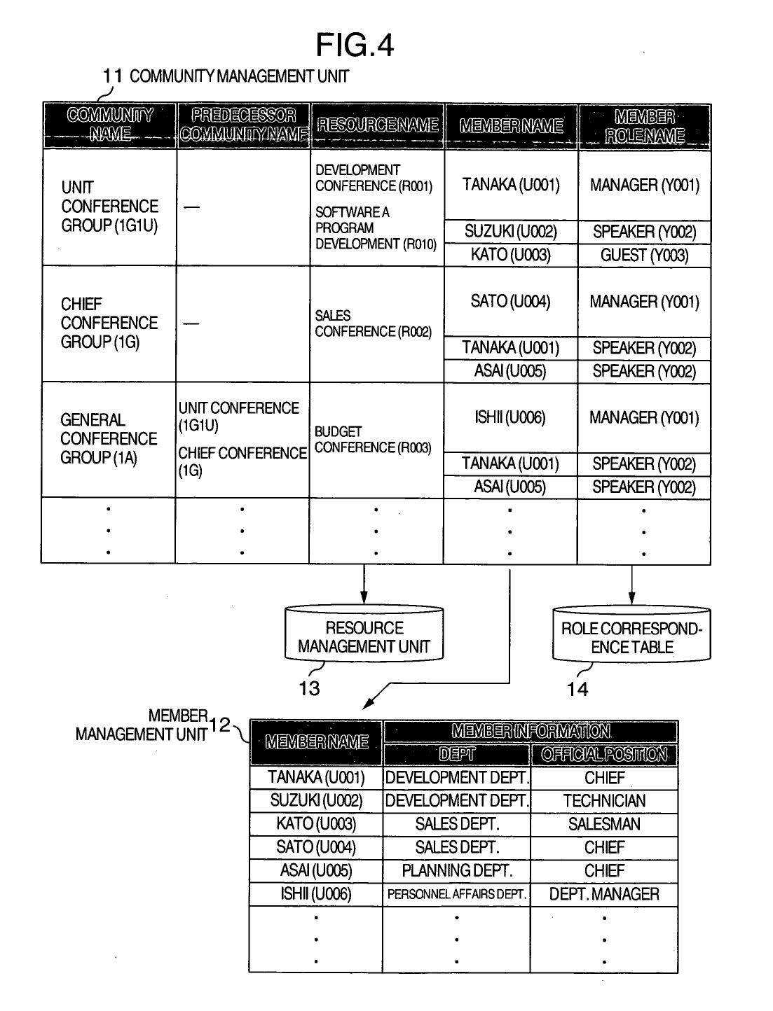

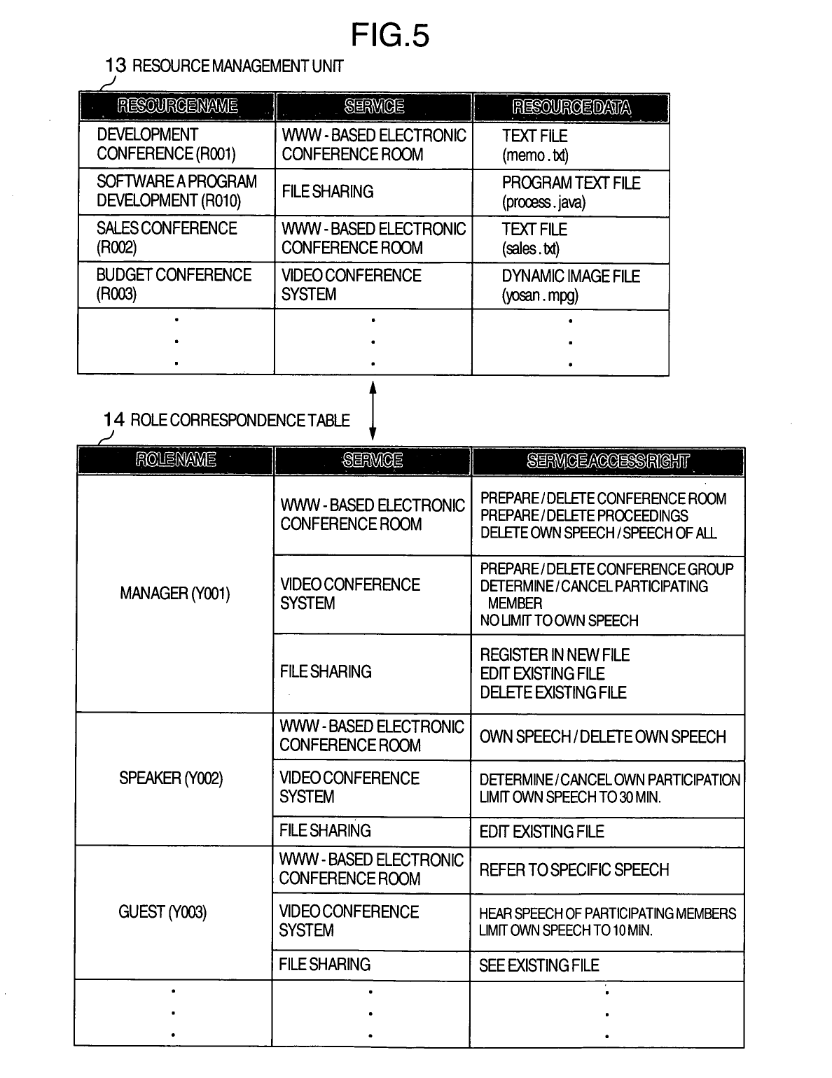

The storage means 10 includes a community management unit 11 (corresponding to “the management table” in the claims) for managing the data on the communities, a member management unit 12 for managing the data on the community members, a resource management unit 13 for managing the data on the community resources and a role correspondence table 14 indicating the correspondence between the role of each member and the right to access the services. Each data in the storage means 10 is explained in detail later with reference to FIGS. 4 and 5.

The community transfer unit 20 includes a member transfer unit 21 for transferring the members from a predecessor community, a role duplication determining unit 22 for uniquely determining a role at the time of duplication of the role assigned to the members, a resource transfer unit 23 for transferring the resources from the predecessor community, and a predecessor community deletion unit 24 for deleting the predecessor community after creating a successor community.

The service provider 30 includes an access controller 31 for limiting the access to a service in accordance with the access right specified from the role of a member, and a service processor 32 for processing the services of a community. The service processor 32 includes a WWW-based electronic conference room processor 32A providing a WWW-based electronic conference room as an example of the service, a file sharing processor 32B for providing the file sharing as an example of the service, and a video conference system processor 32C for providing a video conference system as an example of the service.

In the community management unit 11 shown in FIG. 4, each community corresponds to one record. Each record in the community management unit 11 contains, in correspondence with each other, the community name for identifying a predetermined community, the name of a predecessor community representing a predetermined community, the name of the resources provided by a predetermined community, the names of the members belonging to a predetermined community and the names of the roles assigned to the members having the particular member names. The expression in the parenthesis after each name (“1G1U”, for example, attached after the unit conference group) indicates the ID for specifying the name uniquely and used by the community management apparatus 1 to identify the duplicated name.

In the uppermost record in FIG. 4, for example, the community name “unit conference group” indicates a newly created community (i.e. a community not transferred by any community), which provides two resources including “development conference” and “software A program development”. This community name “unit conference group” is configured of three members including manager “Tanaka”, speaker “Suzuki” and guest “Kato”.

The member management unit 12 in FIG. 4 indicates the information unique to each member (member information) such as the department to which the member belongs and the official position of the member. These member information are used for selecting the members transferred to a community (for example, only the members belonging to a predetermined department).

FIG. 5 is a diagram showing a configuration of the resource management unit 13 of the community management apparatus 1. Each record of the resources contains, in correspondence with each other, the resource name for identifying a resource, the service (application) provided by a resource and the resource data prepared by the particular service.

FIG. 5 is a diagram showing a configuration of the role correspondence table 14 of the community management apparatus 1. The services (applications) provided by the resources are various, and so are the right to access the resource data. In the community management apparatus 1, therefore, the right to access a plurality of services are collected in a single role, and each member is assigned to one role instead of a plurality of access rights. As a result, a community member can be easily defined with a corresponding access right for a reduced management cost. Thus, a role is defined with a role name for identifying the role, a corresponding service (application) provided by the resource and a corresponding service access right.

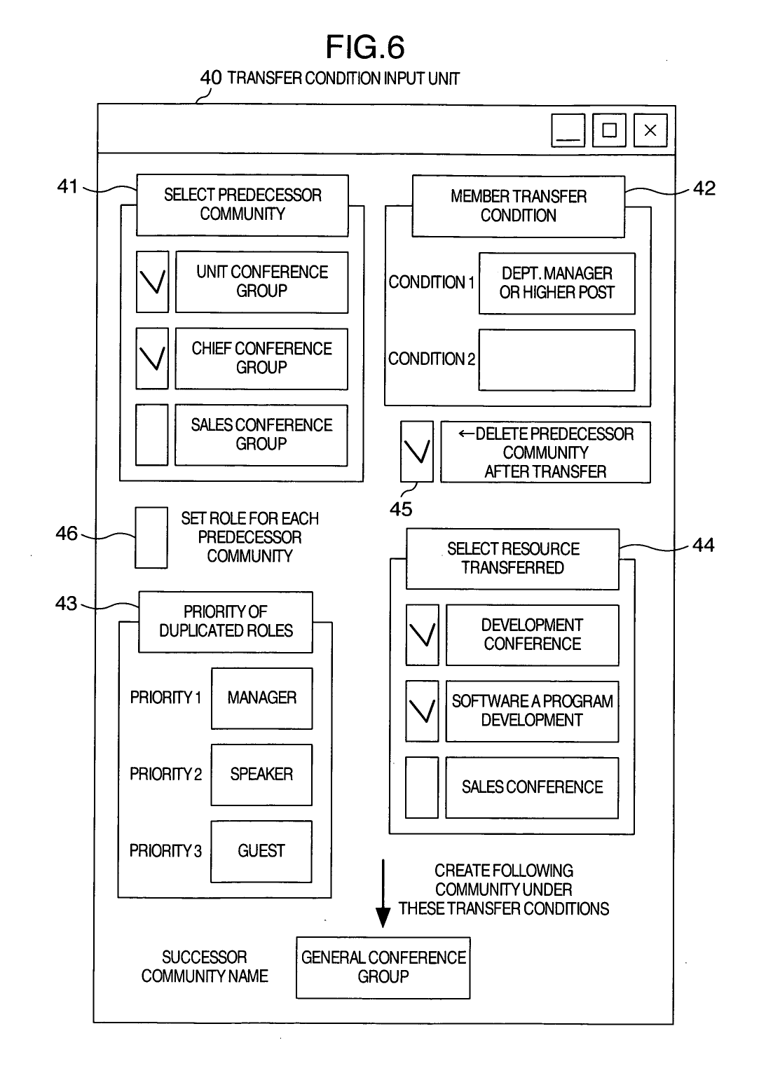

FIG. 6 shows the screen of the transfer condition input unit by which the community management apparatus enables the user to input the transfer conditions. The transfer condition input unit 40 includes a predecessor community selector 41 for causing the user to select a predecessor community from the existing communities, a member transfer condition input unit 42 for causing the user to select the successor members from the predecessor community, a priority role input unit 43 for causing the user to input the priority order for uniquely determining a priority one of the roles duplicated at the time of member transfer, a transfer resource selector 44 for causing the user to select the resource to be transferred from the predecessor community, a predecessor community deletion designating unit 45 for causing the user to designate whether the predecessor community is deleted or not after creating the successor community, and a predecessor community-wise role setting unit 46 for setting the member role in each successor community for each predecessor community.

A list of communities registered in the community management unit 11 and a check box for inputting whether each community is selected or not selected are displayed by the community management apparatus 1 in the predecessor community selector 41. With regard to the community selected by the predecessor community selector 41, a list of the resources provided by the selected community and a check box for inputting whether the resources are selected or not selected are displayed in the transfer resource selector 44 by the community management apparatus 1 with reference to the community management unit 11 and the resource management unit 13.

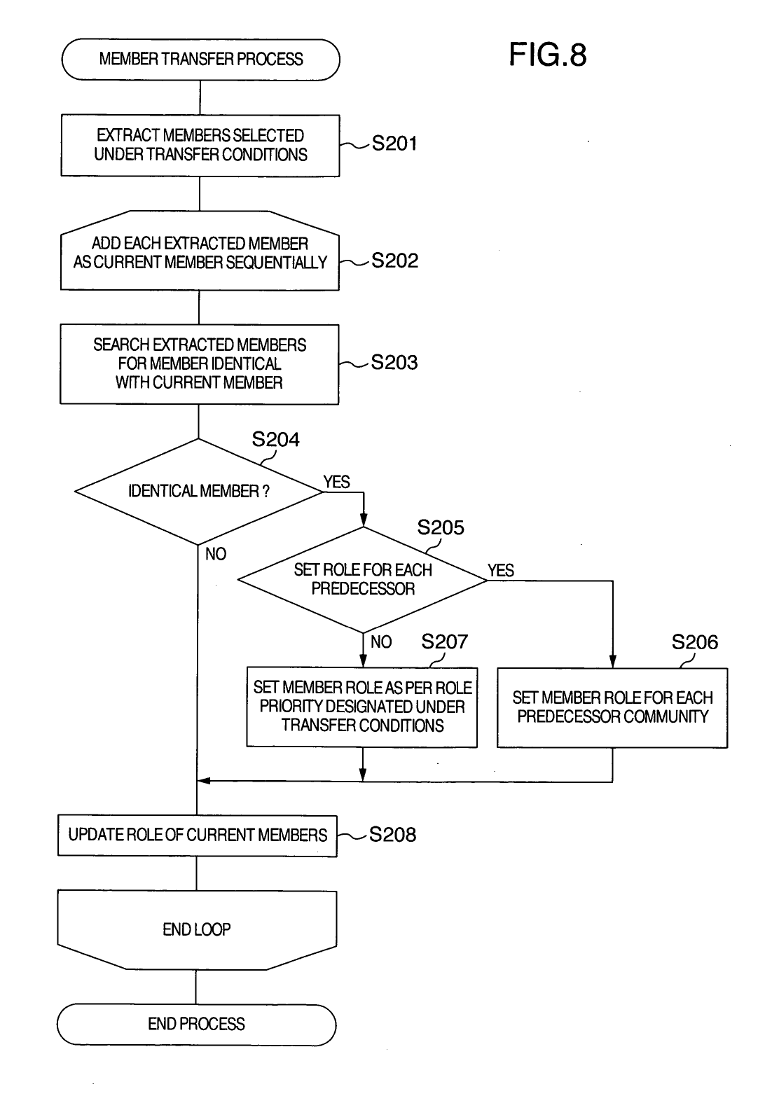

Further, the processes executed based on the information in the two input columns of the transfer resource selector 44 and the predecessor community-wise role setting unit 46 are exclusive (S206 or S207 in FIG. 8 described later). In the case where one of them is selected, therefore, the community management apparatus 1 may invalidate (by not displaying, for example) the other input column.

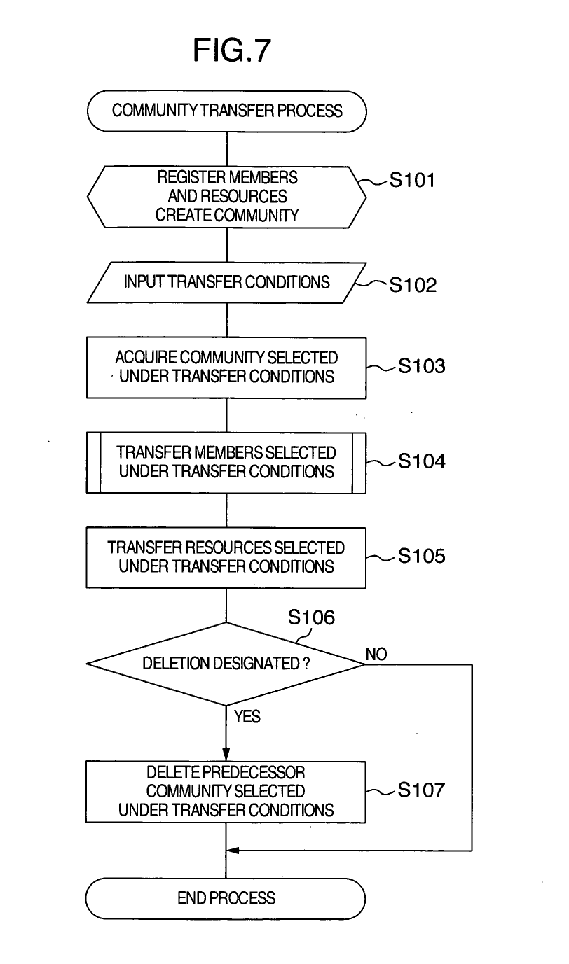

The configuration of the community management apparatus is explained above. Next, the operation of the communication management apparatus according to this embodiment is explained in FIGS. 7 and 8 with reference to FIGS. 1A to 6.

FIG. 7 is a flowchart showing the community transfer process executed by the community management apparatus.

First, the community management apparatus 1 generates a prospective predecessor community in a storage means 10 as a preparation. At the same time, the members corresponding to the prospective predecessor community and the resources are also registered in the storage means 10 (S101).

Next, the community management apparatus 1 receives the input of the transfer conditions through the screen of the transfer condition input unit 40 (S102). The community management apparatus 1 acquires from the community management unit 11 the predecessor community designated by the predecessor community selector 41 with regard to the transfer conditions (S103).

Further, the members meeting the conditions for member search by the member transfer condition input unit 42 with regard to the transfer conditions are selected by the community management apparatus 1 (member transfer unit 21) from the members of the predecessor community acquired at step S103, and the members thus acquired are transferred to the successor community (S104). The members belonging to the predecessor community are acquired by the process of retrieving the information on the correspondence between the communities and the members stored in the community management unit 11. The community management apparatus 1 (resource transfer unit 23) transfers the resource data of the predecessor community designated by the transfer resource selector 44 with regard to the transfer conditions to the successor community (S105). The resource data corresponding to the predecessor community are acquired by the process of retrieving the information on the correspondence between the resource data and the communities stored in the community management unit 11. The transfer at steps S104 and S105 is defined as the computer process of copying the data.

In the community management apparatus 1, whether the predecessor community deletion is designated or not is checked by the predecessor community deletion designation unit 45 with regard to the transfer conditions (S106). In the case where the deletion is designated (YES at step S106), the community management apparatus 1 (the predecessor community deletion unit 24) deletes the predecessor community (S107). This is to execute the transfer process for deleting the predecessor community in FIGS. 1A, 2A.

FIG. 8 is a flowchart showing the member transfer process (S107) by the community management apparatus. In the member transfer process, the role assigned to the community associated with the member is also transferred as well as the information on the particular member (name, etc.). The community management apparatus 1, therefore, acquires in advance the role assigned to the particular member by accessing the community management unit 11.

First, the community management apparatus 1 extracts from the member management unit 12 the member selected by the member transfer condition input unit 42 from those members belonging to the community acquired at step S103 (S201).

Next, the community management apparatus 1 executes the following loop process while designating the members extracted at S201 as current members sequentially (S202). First, the community management apparatus 1 searches the members extracted at S201 for a member identical with a current member (S203), and then confirms whether a member identical with the current member exists or not (S204). In the case where a member identical with the current member exists, it indicates that Mr. A belonging to a first community is identical with Mr. A belonging to a second community.

In the absence of an identical member (NO at S204), the information on the current members is transferred as it is (copied) from the predecessor community to the successor community (S208).

In the presence of an identical member (YES at S204), on the other hand, the community management apparatus 1 executes the process for normalizing the member duplication. First, the predecessor community-wise role setting unit 46 of the community management apparatus 1 checks whether the role setting is designated for each predecessor community (S205).

In the case where the role setting is designated for each predecessor community (YES at S205), the community management apparatus 1 sets the member role for each predecessor community (S206). Assume, for example, that Mr. A belonging to a first predecessor community is assigned the role of manager and Mr. A belonging to a second predecessor community the role of speaker. Mr. A belonging to a third predecessor community is assigned a plurality of roles including the role of manager (in the case where the resource data of the first community is accessed) and the role of speaker (in the case where the resource data of the second community is accessed) (S208).

In the case where the role setting is not designated for each predecessor community (NO at S205), on the other hand, the community management apparatus 1 (duplicated role priority determining unit 22) sets the role of the member in accordance with the priority order of the roles designated by the duplicated role priority input unit 43 (S207). Assume, for example, that the role of manager is assigned to Mr. A belonging to the first predecessor community and the role of speaker to Mr. A belonging to the second predecessor community. Mr. A belonging to the third predecessor community is uniquely assigned the role of highest priority designated by the duplicated role priority input unit 43 (S208).

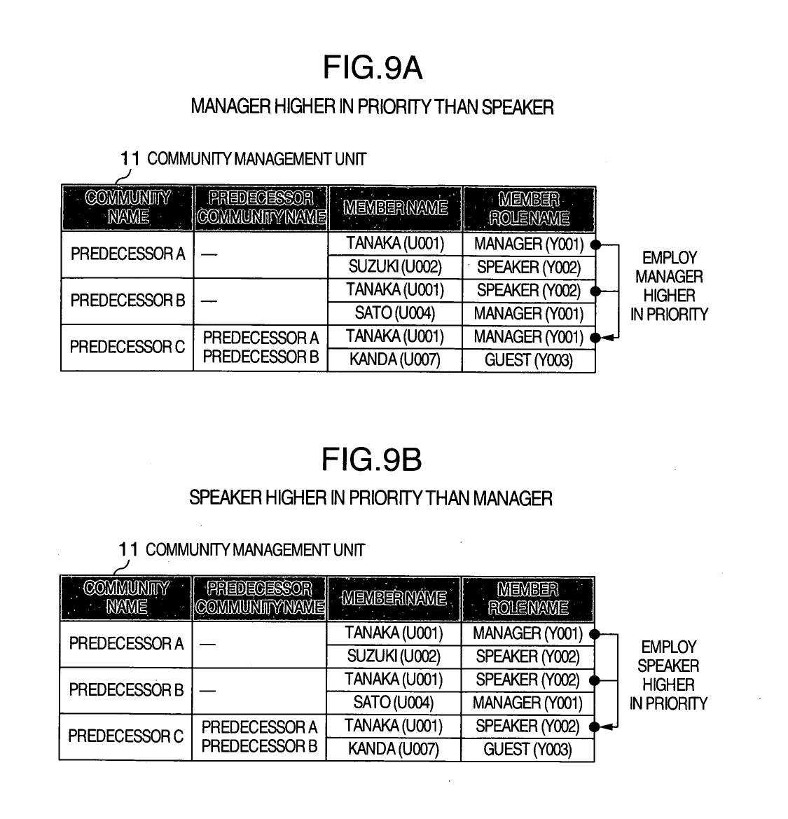

FIGS. 9A, 9B are diagrams for explaining the role priority input by the duplicated role priority input unit 43. FIG. 9A shows the result of member role transfer in the case where the determination that the priority of the role of manager is higher than the priority of the role of speaker is input, and FIG. 9B a case in which the priority reverse to FIG. 9A is input.

First, in FIGS. 9A, 9B, the member Tanaka is assigned the role of manager in the predecessor community A, and the role of speaker in the predecessor community B. The role of the member Tanaka in the predecessor community C is different between FIGS. 9A and 9B. This reflects the process of the community management apparatus 1 in which the role of higher priority input by the duplicated role priority input unit 43 is employed as a role in the successor community.

The configuration according to this embodiment for inputting the role priority produces the following effects. Specifically, in the case where the priority order is set to increase the priority of a high-ranking role (such as the role of manager), the high-ranking role represents a greater proportion of the members of the successor community. As a result, the members engaged in sophisticated jobs attributable to the high-ranking role are increased in number, and therefore a community having many sophisticated jobs (for example, the preparation of the proceedings for the electronic bulletin board system) can be operated smoothly.

In the case where the priority order is set to decrease the priority of a high-ranking role (such as the role of manager), on the other hand, the number of the members engaged in the jobs of high-ranking role is reduced in the successor community. Different opinions, if any, between the members are unified by the members of high-ranking role. Therefore, a smooth business operation is made possible through a quick decision-making process.

According to this embodiment in which the role priority is input at the time of community transfer and the role of each member is transferred based on the input priority order, therefore, the operation features of the successor community can be designated in keeping with the liking of the user at the time of transfer to the community.

The invention described above is variously modifiable without departing from the scope and spirit of the invention.

In FIG. 3, for example, the community management apparatus 1 has a service provider 30. In other words, the service offered by the community is carried out by the community management apparatus 1. As an alternative, a configuration may be employed in which an apparatus other than the community management apparatus 1 has the function of the service provider 30, so that the community management apparatus 1 and the particular other apparatus communicate with each other through a network. As a result, an existing server (such as a file server) having the function of the service provider 30 can be used directly as an object to be managed by the community management apparatus 1. Thus, the development cost and the introduction cost can be reduced.

Also, in the community management apparatus 1, the input screen of the transfer condition input unit 40 may be output on the display unit connected to the community management apparatus 1, and an input may be received from an input device (such as a keyboard and a mouse) connected to the community management apparatus 1. As another alternative, the display screen and the input data may be arranged to communicate with a terminal different from the community management apparatus 1 through a network connected to the community management apparatus 1.

It should be further understood by those skilled in the art that although the foregoing description has been made on embodiments of the invention, the invention is not limited thereto and various changes and modifications may be made without departing from the spirit of the invention and the scope of the appended claims.

1. A community transfer method for a community management apparatus to manage, in correspondence with each other as electronic data in a management table, the data on a community, the members belonging to the community and the resource data constituting the messages exchanged by the members, the data being transferred from a predecessor community to a successor community, the community management apparatus executing the steps of:
receiving the input of transfer conditions;
acquiring from the management table a predecessor community selected under the transfer conditions,
searching the management table for the members corresponding to the acquired predecessor community and transferring the members to the successor community; and
searching the management table for the resource data corresponding to the acquired predecessor community and transferring the resource data to the successor community.

2. A community transfer method according to claim 1,
wherein the step of transferring the resource data to the successor community includes the step of extracting a part of the members meeting the transfer conditions from the members corresponding to the predecessor community selected under the transfer conditions in the management table, and transferring the part of the members to the successor community.

3. A community transfer method according to claim 2,
wherein the members are each assigned a predetermined role for each community and stored in the management table, and
wherein the step of transferring the members to the successor community includes the step of specifying the role of the members of the successor community in accordance with the role priority order input under the transfer conditions in the case where the correspondence in the management table indicates that the same member belongs to a plurality of predecessor communities selected under the transfer conditions.

4. A community transfer method according to claim 2,
wherein the members are each assigned a predetermined role for each community and stored in the management table, and
wherein the step of transferring the members to the successor community includes the step of setting the role of a member of each predecessor community assigned by the management table, as the role of the member of the successor community, in the case where the correspondence in the management table indicates that the same member belongs to a plurality of predecessor communities selected under the transfer conditions.

5. A community transfer method according to claim 4,
wherein the step of transferring the resource data to the successor community includes the step of transferring the resource data selected out of the resource data corresponding to the predecessor community under the transfer conditions in the management table to the successor community.

6. A community transfer method according to claim 2,
wherein the step of transferring the resource data to the successor community includes the step of transferring the resource data selected out of the resource data corresponding to the predecessor community under the transfer conditions in the management table to the successor community.

7. A community transfer method according to claim 3,
wherein the step of transferring the resource data to the successor community includes the step of transferring the resource data selected out of the resource data corresponding to the predecessor community under the transfer conditions in the management table to the successor community.

8. A community transfer method according to claim 7,
wherein the step of receiving the input of the transfer conditions includes the step of selecting whether the predecessor community is deleted or not, and the step of deleting the predecessor community after creating the successor community in the case where the data is input designating the deletion of the predecessor community.

9. A community transfer method according to claim 1,
wherein the step of receiving the input of the transfer conditions includes the step of selecting whether the predecessor community is deleted or not, and the step of deleting the predecessor community after creating the successor community in the case where the data is input designating the deletion of the predecessor community.

10. A community transfer method according to claim 2,
wherein the step of receiving the input of the transfer conditions includes the step of selecting whether the predecessor community is deleted or not, and the step of deleting the predecessor community after creating the successor community in the case where the data is input designating the deletion of the predecessor community.

11. A community transfer method according to claim 3,
wherein the step of receiving the input of the transfer conditions includes the step of selecting whether the predecessor community is deleted or not, and the step of deleting the predecessor community after creating the successor community in the case where the data is input designating the deletion of the predecessor community.

12. A community transfer method according to claim 4,
wherein the step of receiving the input of the transfer conditions includes the step of selecting whether the predecessor community is deleted or not, and the step of deleting the predecessor community after creating the successor community in the case where the data is input designating the deletion of the predecessor community.

13. A community transfer method according to claim 5,
wherein the step of receiving the input of the transfer conditions includes the step of selecting whether the predecessor community is deleted or not, and the step of deleting the predecessor community after creating the successor community in the case where the data is input designating the deletion of the predecessor community.

14. A community transfer method according to claim 6,
wherein the step of receiving the input of the transfer conditions includes the step of selecting whether the predecessor community is deleted or not, and the step of deleting the predecessor community after creating the successor community in the case where the data is input designating the deletion of the predecessor community.

15. A community management apparatus for managing the data on communities, comprising:
a management table for managing electronic data containing, in correspondence with each other, the data on a community, the members of the community and the resource data constituting the messages exchanged by the members;
a transfer condition input unit for receiving the input of the transfer conditions for creating a successor community;
a member transfer unit for searching the management table for a member corresponding to the predecessor community input by the transfer condition input unit and transferring the member to the successor community; and
a resource transfer unit for searching the management table for the resource data corresponding to the predecessor community input by the transfer condition input unit and transferring the resource data to the successor community.

16. A community management apparatus according to claim 15, further comprising a duplicated role determining unit for uniquely determining the role assigned to a member of the successor community based on the role priority order input by the transfer condition input unit in the case where the role assigned to the member in the management table is duplicated between a plurality of communities at the time of member transfer.

17. A community management apparatus according to claim 15,
wherein the member transfer unit extracts a part of the members meeting the transfer conditions out of the members corresponding to the predecessor community selected under the transfer conditions in the management table, and transfers the part of the members to the successor community.

18. A community management apparatus according to claim 15,
wherein the members are each assigned a predetermined role for each community and stored in the management table, and
wherein the member transfer unit sets the role of a member assigned in the management table for each predecessor community as the role of the member of the successor community in the case where the management table contains the correspondence of the same member belonging to a plurality of the predecessor communities selected under the transfer conditions.

19. A community management apparatus according to claim 15,
wherein the resource data transfer unit transfers the resource data selected under the transfer conditions to the successor community out of the resource data corresponding to the predecessor community selected under the transfer conditions in the management table.

20. A community management apparatus according to claim 15,
wherein the transfer condition input unit has the function of selecting whether the predecessor community is to be deleted or not, and in the case where the data on deletion of the predecessor community is input, the predecessor community is deleted after creating the successor community.

21. A community management program wherein a computer, including at least a memory as a storage area used for the arithmetic operation and an operation processor for executing the arithmetic process, functions as
a management table containing, as electronic data in correspondence with each other, on a community, at least a member belonging to the community and resource data providing the messages exchanged by the members,
a transfer condition input unit for receiving the input of the transfer conditions at the time of creating the successor community,
a member transfer unit for searching the management table for a member corresponding to the predecessor community input by the transfer condition input unit and transferring the member to the successor community, and
a resource transfer unit for searching the management table for a resource data corresponding to the predecessor community input by the transfer condition input unit and transferring the resource data to the successor community.
